(19) United States
(12) Patent Application Publication
(10) Pub. No.: US 2009/0208904 A1
(43) Pub. Date: Aug. 20, 2009

(54) Dental implant

(76) Inventor: Maris J. Lans, Highland Park, IL (US)

Correspondence Address: J.W. Gipple;GIPPLE & HALE, P.O. Box 40513, Washington, DC, 20016, US

(21) Appl. No.: 12/070,112

(22) Filed: Feb. 19, 2008

(51) Int. Cl. A61C 8/00

(52) U.S. Cl. 433/173

(57) ABSTRACT

A dental implant is described, which has an internal axial force absorbing the dissipating member encased within resilient material so as to suspend a prosthetic supporting section.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### INCORPORATED-BY-REFERENCE OF MATERIAL SUBMITTED ON A COMPACT DISC

NOT APPLICABLE

### BACKGROUND OF THE INVENTION

(1) Field of the Invention

This invention is directed to dental implants with a design that is conducive to the dissipation of forces generated by occlusion and/or mastication, and to compensate for deleterious forces that may occur as a result of either temporary or repetitive parafunctional occlusal environments, and to be more compatible with the variation and/or change over periods of time in the periodontal apparatus of the approximating and opposing dentition.

Dental implants are without argument, one of the most important advances in the field of Dentistry in this century. According to Statistics, as of the date of submission of this application, there are no fewer than 1403 patents issued for various aspects for Dental implant design, and related characteristics. The commonality with implants of any design in the marketplace today, is that they are manufactured of rigid materials, and the successful outcome of any implant placement totally relies on the osseointegration of the particular implant within either the maxillary or mandibular alveolar bone. The vast majority of dental implant failures are caused either by the unsuccessful and/or inadequate osseointegration of the implant within the alveolar bone, or the results of deleterious torque on the implant despite successful osseointegration either through normal forces of occlusal and masticatory function, or a result of deleterious forces as a result of either temporary or repetitive parafunctional occlusal environments, or the incompatibility of an essentially rigidly integrated structure (the implant body and its assembly) approximating and/or opposing structures that have a resiliency (natural teeth or natural teeth supporting a prosthesis) as a result of their function within the normal periodontal apparatus.

Changes occur in the relative health and integrity of the periodontal apparatus over the course of time due to a variety of reasons, none of which can be compensated for with a variation of the otherwise rigidly anchored implant. Hence, as the surrounding natural structures become somewhat more resilient over time in most cases, i.e., the natural dentition tends to exhibit more mobility due to the decrease in supporting bone and associated periodontal ligaments, the torque of the implant, in relative terms becomes more marked and can easily change from tolerable to destructive over a relatively short period time, and relegate the implant to failure. The present invention allows for the retrieval and/or replacement of the shock absorbing sleeve, without compromising either the implant to bone osseointegrated interface, or the prosthetic coronal components of the assembly. Depending on the chemical composition of the shock absorbing sleeve, the diameter of the internal axial member of the implant, or a combination of two variables, the resiliency of the shock absorbing sleeve can be modified to be more compatible with the ascertained status of the particular patient's periodontal apparatus, i.e., a stiffer resiliency in a younger patient, and a more forgiving resiliency in an older patient. In patients where the implant assembly is being utilized to house attachments for full prosthetics, the ability to have variable resiliency in the shock absorbing sleeve is critical, especially when there may be less than favorable dimensions of the supporting alveolar bone, as is often the case in advanced resorption of the mandible, where implants could offer a marked improvement in the ability of the patient to function with a full arch prosthesis. Operator technique in the placement of implants is probably the most critical and variable factor in their outcome as well, inasmuch as the placement of any implant deviating even a few degrees from ideal, where the torque forces are displaced axially along the body of an implant as they would be in a natural tooth, can mean the difference between an implant that either osseointegrates successfully, or withstands the forces of occlusion and mastication for an acceptable lifespan of service. The ability of the implant assembly to absorb and dissipate torque can allow for the discrepancy of a few degrees from ideal, without adversely affecting the long-term outcome of the implant and its associated prosthetic assembly.

(2) Description of Related Art

Applicant is aware of no prior art directly relevant to the present invention.

### BRIEF SUMMARY OF THE INVENTION

In accordance with the present invention, internally force dissipating dental implant is comprised of a conventional implant body, with the bone approximating surfaces being either threaded, or non-threaded for a frictional fit and those surfaces being either uncoated, or coated with a hydroxyl apatite chemistry or other surface coating chemistry to induce the osseointegration of the implant with the surrounding bone, and having an internal configuration designed with an axial member that is machined at the coronal end to accept a dowel, either screw retained, or cemented, that would support the coping and crown portion of the prosthetic tooth or an anchorage for an overdenture attachment, and an apical end that is machined with a ball joint configuration. The entire internal assembly is encased within the body of the implant within a shock absorbing sleeve comprised of a biologically inert, (polyethylene or comparable resilient interface material) so that the coping and the crown portion of the prosthetic tooth along with the axial member and the apical ball joint are actually suspended within the implant body with the ability to move within pre-described limits in a coronal-apical direction, and antero-posterior (mesial-distal) direction, and a bucal/labial linguo-palatal direction, or any combination of these directions simultaneously, i.e., along any of the three dimensional axis. The resiliency of the material suspending the internal member of the implant would be available with different degrees of resiliency so as to be more compatible with the integrity of the periodontal apparatus of the approximating and opposing natural dentition and/or previous prosthetic replacement(s). The entire internal assembly is retrievable and replaceable without compromising the implant body itself, or the dowel, coping or coronal portion of the prosthetic tooth in the event the conditions would indicate a change in the resiliency requirements of the interface material. The dimension of the internal axial member would also be available in different diameters, while the apical portion of the component would be standardized to allow for its replacement as needed without compromising the implant body to bone interface, or the prosthetic device that was originally fabricated to restore the clinical crown portion of the assembly.

### BRIEF DESCRIPTION OF THE DRAWINGS

FIG. 1 is a cross sectional side view of a dental implant embodying the present invention.

FIG. 2 is a cross sectional top view of said dental implant taken at line A-A of FIG. 1.

FIG. 3 is a cross sectional top view of said dental implant taken at line B-B of FIG. 1.

### DETAILED DESCRIPTION OF THE DRAWINGS

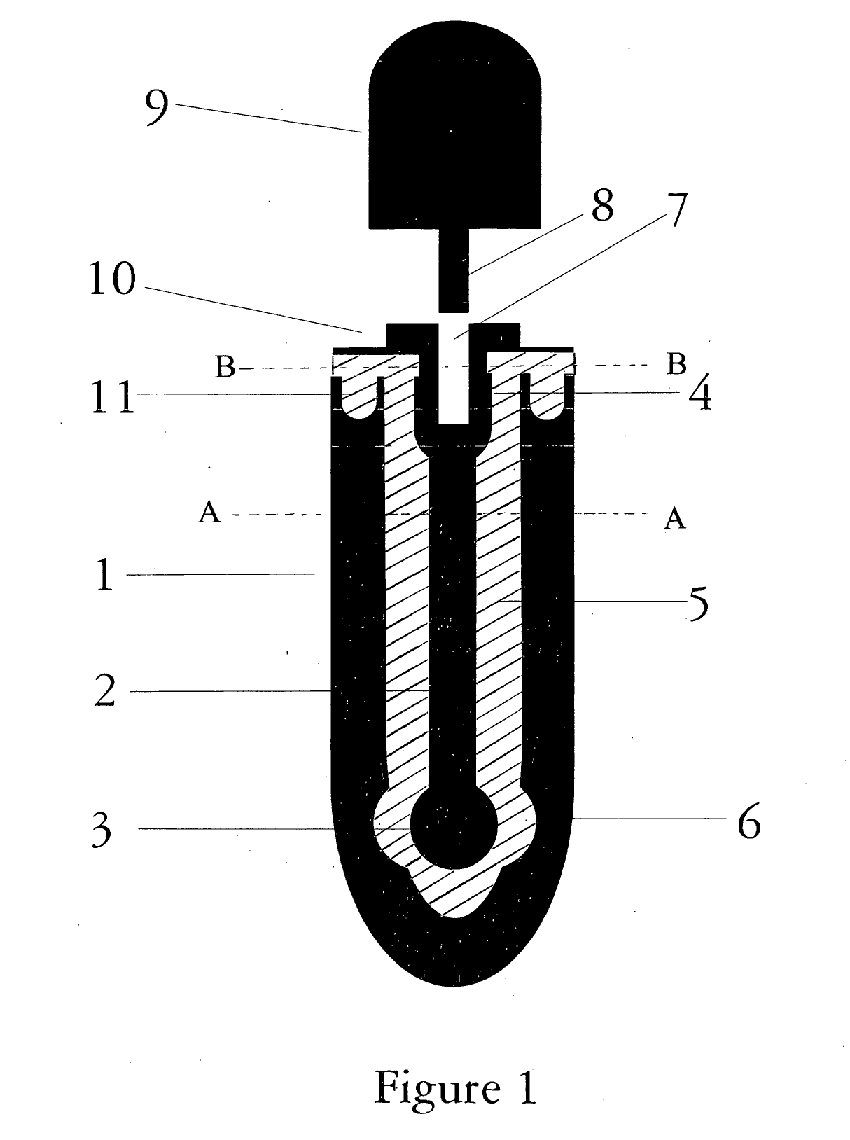

FIG. 1 illustrates the embodiment of the present invention, which is a dental implant body (1) designed in such a way as to incorporate an internal axial force absorbing/force dissipating member (2) encased within a polyethylene, a Kevlar based composite, a Gortex based matrix, carbon fiber matrix or other polymeric material composition sleeve (5) so as to suspend the prosthetic/anchorage supporting section (4) and (10) of member (2) and the prosthetic appliance or anchoring device (8) and (9).

Component 1 in FIG. 1 illustrates the implant body. It may be threaded, or non-threaded, coated with a bone growth stimulating material such as hydroxyl-apatite, or uncoated. It is fabricated out of titanium, but may also be fabricated out of a ceromer material.

Contained with the hollow interior cavity of the implant body (1) is a sleeve (5), which is fabricated out of polyethylene, a Kevlar based composite, a Gortex based matrix, carbon fiber matrix, or other polymeric material composition. The purpose of the sleeve (5) is to anchor, support and contain the axial member (2) inside of the implant body (1). The axial member (2) has at is apical end a spherical or spheroidal shaped pendulum that locks the member within the sleeve (5), which in turn is locked into the implant body by circumferential semi-lunar recesses (6) that coincide with the position of the spherical or spheroidal shaped pendulum at the apical end of the axial member (2). The opposite, or coronal end of the axial member (2) contains either a threaded or non-threaded receptacle (7), into which either a screw retained or cemented or bonded dowel (8) can be placed, to which a core to support a fixed prosthetic tooth or multiple tooth fixed appliance can be connected, or any anchoring or attachment device to which can be connected a removable prosthetic appliance, such as an over-denture. The coronal end of the axial member also is comprised of a circumferential flange (10) upon which may be seated any of the prosthetic components just described. The flange (10) will be isolated from the coronal end of the implant body by the extension of the sleeve material (5) to act as a cushioning O-ring between the flange (10) and the implant body (1), by having a recess (11) into the coronal lip of the implant body (1).

The axial member (2) is fabricated out of titanium, or ceromer material, or carbon fiber or any combination of materials to allow sufficient strength to withstand the torqueing forces acting upon it, without being distorted or damaged.

In applications where the prosthetic replacement may be in intimate contact with adjacent natural dental structures, the axial member (2) within the resilient sleeve (5) will allow the prosthetic assembly to move within the limits of the surrounding structures without transmitting all of the forces directly onto the bone-implant body interface.

The sleeve material (5) is available in different degrees of resiliency by altering the chemical composition of the polyethylene or other material of which it may be fabricated so as to offer different degrees of resistance to the torqueing forces acting upon the assembly.

The vector forces acting upon any dental implant will be the same as those forces acting upon natural dentition The major difference is that in the presence of a healthy periodontal ligament, the natural dentition is able to absorb and dissipate these vector forces via a simple, yet complex network of fibers that collectively act as shock absorber to prevent the compression of the tooth root into the socket and thereby damaging and or destroying the capillaries and nerve supply into the apex of the tooth root. Implants, while an attempt to restore the anchoring properties of a natural tooth root, cannot accommodate the absorption of functional forces beyond the resiliency properties of the supporting bone, as the success of any implant is predominantly judged by the extent of osseointegration with the bone surrounding the implant body, which, by and large is a rigid union.

The majority of implant failures are the result of this rigid union between the implant body and the surrounding bone either being incomplete from the early stages of the implant placement, or as the result of the union being compromised by the inadequate strength of the bone in close approximation to the implant body/bone interface. In most cases of post prosthetic restoration failures, the implants were loosened and subsequently lost as a result of torquing forces that wrenched the implant body from the surrounding bone.

The present invention would follow the accepted protocols of placement and healing periods for oseointegration of the implant body to take place. The prosthetic crown or overdenture attachment would be affixed to the internal force absorbing/dissipating member (2) by means of either a screw retained or cemented dowel (8) that would fit into a threaded female receptacle (7) and support a core portion (9) upon which the prosthetic crown would be fabricated. In the event that the implant was being used to support an overdenture fixture, the core (9) would be either the male or female portion fabricated to fit the reciprocal fitting in the overlying prosthetic appliance. In the case of an overdenture attachment, there would be no prosthetic crown affixed to the core (9) would be in and by itself, the actual attachment fixture.

In either a prosthetic crown or overdenture configuration, the loading upon the coronal assembly would be cushioned against by the disc like configuration of the biologically inert shock absorbing material (5) under the flange portion (10) of the coronal portion of the assembly. The range of motion allowed would be a factor of the resiliency property of the shock absorbing material (5) and the encased ball joint geometry (3) at the apical end of the internal member (2). The shape of the internal member (2) would force the vector acting upon the coronal assembly to be dissipated along the internal member (2) where the forces would be further dampened by the shock absorbing material (5) while at the same time redirecting the force vector apically, as opposed to strictly a lateral direction, where the forces would have a potentially deleterious torquing effect on the bone surrounding the implant body. Forces that would be aimed predominantly in an apical direction to begin with, would be dampened by the buttressed configuration (11) of the shock absorbing material into the coronal aspect of the implant body (1) between the implant (1) and the flange portion (10) of the coronal assembly of the internal member (2).

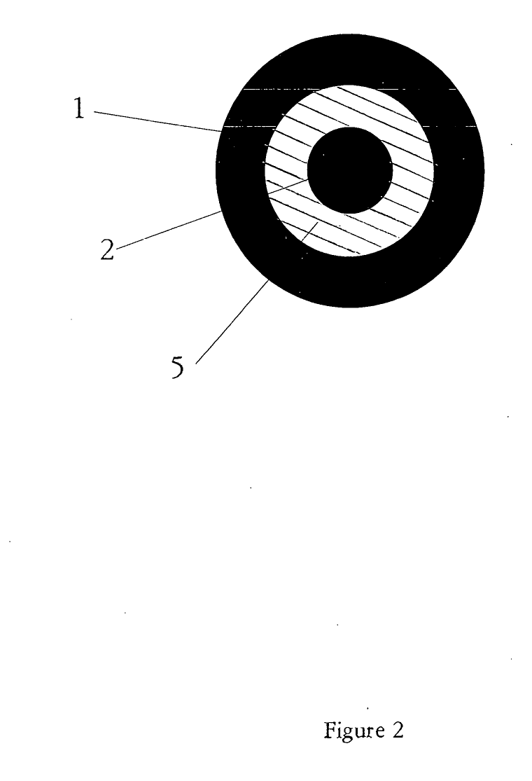

FIG. 2 shows the relationship between the implant body (1) and the internal axial member (2) and the shock absorbing material (5) that is placed in and between the two to act as a cushion between the two rigid members (1) and (2).

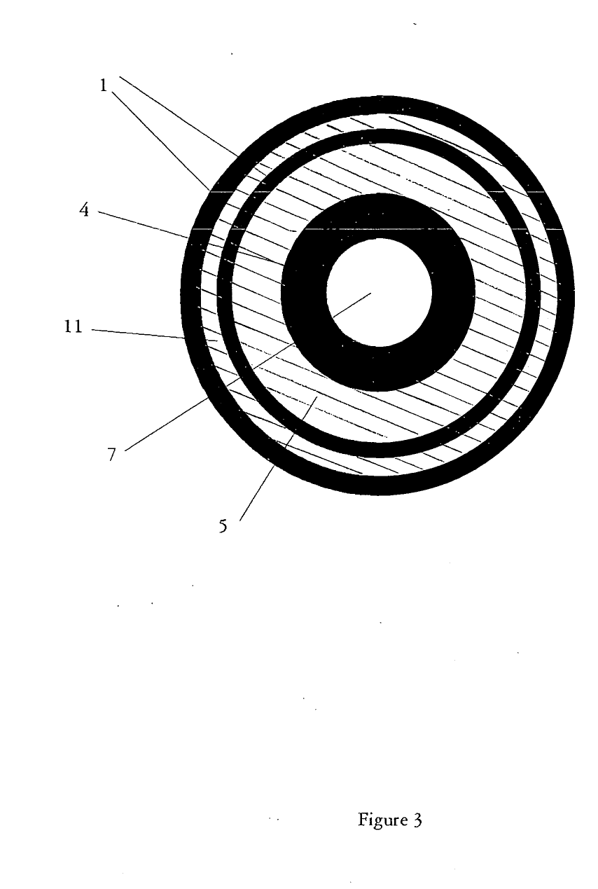

FIG. 3 shows the relationship between the female receptacle (7) within the axial member coronal portion (4) and the shock absorbing material (5) that is in between the implant body (1) and the flange assembly (4) and the buttressed portion (11) that supports the flange portion (10) of FIG. 1.

It is intended that the foregoing detailed description be regarded as illustrative rather than limiting and that it be understood that it is the following claims, including all equivalents which are intended to define the scope of the invention.

What is claimed is:

1. A dental implant comprising an implant body and means within said body to absorb and dissipate force.

2. The implant of claim 1, wherein said means to absorb and dissipate force comprises an internal axial member incased in a resilient sleeve.

3. The implant of claim 2, wherein the upper end of the axial member includes a flange extending out over the said implant body.

4. The implant of claim 3, wherein said upper end provides a means to attach a core portion suitable for supporting a prosthesis.

5. The implant of claim 4, wherein said means to attach is a female receptacle for receiving a dowel extending downwardly from aid core portion.

6. The implant of claim 5, wherein said dowel and said female receptacle are threaded.

7. The implant of claim 2, wherein the lower extremity of said internal axial is formed into a ball joint geometry.

8. The implant of claim 3, wherein the material which comprises said resilient sleeve, extends above the said implant body and beneath said flange.

9. The implant of claim 8, which includes a recess extending around the upper periphery of said implant body, into which said resilient sleeve material extends.

10. The implant of claim 2, wherein the material comprising said resilient sleeve is a polymeric composition.

11. The implant of claim 10, wherein said material is polyethylene.

12. The implant of claim 2, wherein said internal axial member is formed of titanium.

13. The implant of claim 2, wherein said member is formed of ceromer material.

14. The implant of claim 2, wherein said member is formed of
